(19) United States
(12) Patent Application Publication
(10) Pub. No.: US 2013/0242809 A1
(43) Pub. Date: Sep. 19, 2013

(54) MOBILE COMMUNICATION TERMINAL MODULE AND MOBILE COMMUNICATION TERMINAL

(71) Applicants: MASAZUMI TONE, Ebina (JP); AKIO YAMAMOTO, Hiratsuka (JP); TAKASHI SHIBA, Yokosuka (JP); OSAMU HIKINO, Yokohama (JP)

(72) Inventors: MASAZUMI TONE, Ebina (JP); AKIO YAMAMOTO, Hiratsuka (JP); TAKASHI SHIBA, Yokosuka (JP); OSAMU HIKINO, Yokohama (JP)

(73) Assignee: Hitachi Media Electronics Co., Ltd.

(21) Appl. No.: 13/617,767

(22) Filed: Sep. 14, 2012

(30) Foreign Application Priority Data
Dec. 16, 2011 (JP) 2011-276060

(51) Int. Cl. H04L 5/14

(52) U.S. Cl. CPC H04L 5/14
USPC 370/277

(57) ABSTRACT

In a tunable duplexer combining a tunable filter with a canceler, calibration for optimizing passband characteristics and stop band characteristics is accelerated, and the deterioration of performance due to variations is highly accurately compensated. The tunable filter is calibrated to acquire isolation characteristics, and then coarse calibration and fine calibration are performed on the canceler. In coarse calibration, the use band of the tunable filter is set to a suppression band, and the isolation characteristics of the canceler are acquired. An amplitude, a phase, and a bias voltage are adjusted based on a result of comparison with the acquired isolation characteristics of the tunable filter for determining an approximate convergence. Fine calibration is further performed, and the optimum point is determined in a narrow range near the convergence.

### INCORPORATION BY REFERENCE

This application relates to and claims priority from Japanese Patent Application No. 2011-276060 filed on Dec. 16, 2011, the entire disclosure of which is incorporated herein by reference.

### BACKGROUND OF THE INVENTION

1. Field of the Invention

The present invention relates to a mobile communication terminal module and a mobile communication terminal. More particularly, the present invention relates to a mobile communication terminal module and a mobile communication terminal conforming to wireless communication systems such as the WCDMA (Wideband Code Division Multiple Access) mode and the LTE (Long Term Evolution) mode, for example.

2. Description of the Related Art

In the mobile telephone, the adaptation of the LTE mode is being considered in addition to the WCDMA already in practical use. Since transmission and reception are operated simultaneously in the WCDMA mode and the LTE mode, different bands are used for the transmit frequency and the receive frequency. In the modes, a duplexer that separates the transmission band from the reception band is used.

“Adaptive Duplexer Implemented Using Single-Path and Multipath Feedforward Techniques With BST Phase Shifters, IEEE TRANSACTIONS ON MICROWAVE THEORY AND TECHNIQUES, VOL. 53, NO. 1, JANUARY, 2005” describes a method for canceling thermal noise in the reception band in order to compensate the shortage of out-of-band suppression of a duplexer. Transmit signals are removed using a notch filter. Moreover, for thermal noise in the reception band generated by a transmitter, the amplitude and the phase are adjusted, and the thermal noise is combined with transmit and receive signals between the duplexer and the antenna end, and then removed. With the removal of the thermal noise, the thermal noise in the reception band is canceled while suppressing the influence on transmit signals to be small.

In the WCDMA mode and the LTE mode, a plurality of channels are included in a plurality of frequency bands and in the same band, and duplexers are individually provided for frequency bands in a mobile telephone front end module in order to obtain excellent radio frequency characteristics. Furthermore, since the LTE mode adopts MIMO (Multiple Input Multiple Output) techniques to implement an increase in speed, receivers are necessary for the number of antennas. Since it is expected to increase the receiver scale in association with in a future increase in speed, techniques to tunably switch duplexers are necessary as described in Japanese Patent Application Laid-Open No. 2011-120120.

Japanese Patent Application Laid-Open No. 2011-120120 describes a tunable filter technique and a canceler technique to tunably switch a duplexer. The canceler technique is a technique that compensates a shortage of the out-of-band signal suppression amount of a variable tunable filter to selectively transmit a plurality of frequency bands. A canceler cancels the leakage component of the transmit signal and the leakage component of thermal noise in the reception band included in receive signals outputted from a tunable filter.

Japanese Patent Application No. 2010-233607 (Laid-Open No. 2012-089995) describes that the canceler can highly accurately provide cancel values by including a filter showing characteristics equivalent to the tunable filter. There are a method for attenuating the leakage component of the transmit signal and thermal noise in the reception band using a canceler in one system and a method for separately attenuating the leakage component of the transmit signal and thermal noise in the reception band using cancelers in two systems.

Japanese Patent Application No. 2010-287756 (Laid-Open No. 2012-138651) describes that the canceler includes a filter showing characteristics equivalent to the tunable filter, a matching circuit that adjusts amplitudes, phases, and delay, a wide band amplifier that amplitude variations and phase swinging are gentle from the frequency band of the transmit signal to the frequency band of the receive signal, a transmission side variable impedance coupler, and a reception side variable impedance coupler in which a delay device corresponding to the group delay of the wide band amplifier is provided on the signal path of the tunable filter to highly accurately provide cancel values. There are a method for attenuating the leakage component of the transmit signal and thermal noise in the reception band using a canceler in one system and a method for separately attenuating the leakage component of the transmit signal and thermal noise in the reception band using cancelers in two systems.

Japanese Patent Application No. 2011-123541 describes a calibration technique and a control method preferably for use in using the canceler and the tunable filter in a terminal. A calibration signal from the transmission system of the terminal and the power detector of a reception system are used to calibrate performances such as the passband characteristics and stop band characteristics of the canceler and the tunable filter to match with optimum values, calibrated data is stored, and the data is read when operating for implementing excellent transmission-reception characteristics. The tunable filter individually calibrates the passband characteristics and the stop band characteristics for optimization, and the canceler individually calibrates the stop band frequency and the attenuation value of the stop band for optimization.

### SUMMARY OF THE INVENTION

Although the Tx (transmission)-Rx (reception) isolation characteristics of the tunable filter are not better than the Tx-Rx isolation characteristics of a typical duplexer, the tunable duplexer having a tunable filter combined with a canceler shows characteristics equivalent to the characteristics of a typical duplexer or more. However, in the case where variations occur due to devices, power supply voltage, and temperature, such a problem arises in that the performance of the canceler deteriorates. Moreover, although calibration can optimize performances such as passband characteristics and stop band characteristics, such a problem arises in that it takes time to optimize the amplitude and the phase, for example.

It is an object of the present invention to speed up calibration in a tunable filter to meet a plurality of frequency bands while highly accurately compensating the deterioration of performance.

In order to solve the problems, the present invention is a mobile communication terminal module that simultaneously operates transmission and reception using a transmit frequency and a receive frequency in different bands. The mobile communication terminal module includes: a filter configured to separate a transmit signal from a receive signal, the filter including a variable characteristic to selectively transmit a plurality of frequency bands; and a canceler configured to cancel a transmit signal and thermal noise in a reception band leaking from a transmission side to a reception side by a predetermined amount. The canceler includes an amplifier having a calibrating unit. The calibrating unit includes an amplitude adjusting unit, a phase adjusting unit, and a bias adjusting unit.

Moreover, the present invention is a mobile communication terminal that simultaneously operates transmission and reception using a transmit frequency and a receive frequency in different bands. The mobile communication terminal includes: a filter configured to separate a transmit signal from a receive signal, the filter including a variable characteristic to selectively transmit a plurality of frequency bands; and a canceler configured to cancel a transmit signal and thermal noise in a reception band leaking from a transmission side to a reception side by a predetermined amount. The canceler includes an amplifier having a calibrating unit. The calibrating unit includes an amplitude adjusting unit, a phase adjusting unit, and a bias adjusting unit. The calibrating unit performs a plurality of steps of calibration to cancel the transmit signal and thermal noise in the reception band leaking from the transmission side to the reception side by a predetermined amount, performs coarse calibration, and performs fine calibration.

According to the present invention, it is possible to speed up calibration, it is possible to highly accurately compensate the deterioration of performance due to variations, and it is possible to improve the basic performances of a mobile communication terminal module and a mobile communication terminal using the same.

### BRIEF DESCRIPTION OF THE DRAWINGS

These and other features, objects, and advantages of the present invention will become more apparent from the following description when taken in conjunction with the accompanying drawings wherein:

FIG. 1 is a block diagram of an exemplary configuration of a mobile communication terminal module according to a first embodiment;

FIG. 2 is a circuit diagram of an amplifier including a calibrating unit according to the first embodiment;

FIG. 3 is a flowchart of calibration according to the first embodiment;

FIG. 4 is a diagram of the characteristics of a band 18 according to the first embodiment;

FIG. 5 is a diagram of the characteristics of a band 5 according to the first embodiment;

FIG. 6 is a diagram of the characteristics of a band 8 according to the first embodiment;

FIG. 7 is a diagram of the characteristics of a band 18 according to the first embodiment before calibrated;

FIGS. 8A and 8B are diagrams of the Tx-Rx isolation characteristics of a tunable filter and the Tx-Rx isolation characteristics of a canceler of the band 18 according to the first embodiment;

FIG. 9 is a diagram of the characteristics of the band 18 according to the first embodiment after calibrated;

FIG. 10 is a block diagram of an exemplary configuration of a mobile communication terminal according to the first embodiment;

FIG. 11 is a block diagram of an exemplary configuration of a mobile communication terminal module according to a second embodiment; and

FIG. 12 is a block diagram of an exemplary configuration of a mobile communication terminal module according to a third embodiment.

### DETAILED DESCRIPTION OF THE EMBODIMENT

In the following, embodiments of the present invention will be described.

### First Embodiment

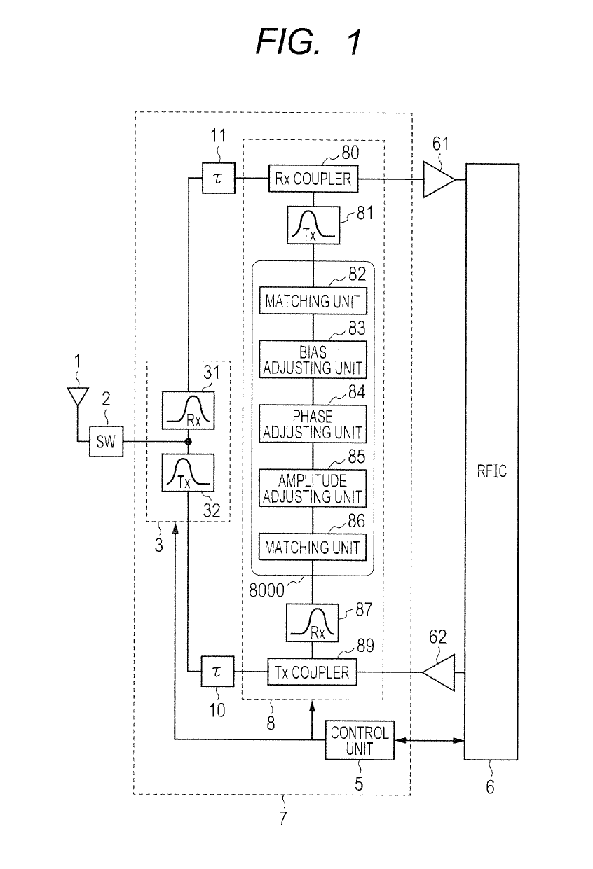

FIG. 1 is a block diagram of an exemplary configuration of a mobile communication terminal module according to a first embodiment. The configuration of the embodiment is targeted for mobile communication terminal modules in the WCDMA mode and the LTE mode, for example. However, the configuration of the embodiment is not limited thereto. The configuration of the embodiment is also used for mobile communication terminal modules in which different bands are allocated to the transmit frequency and the receive frequency for simultaneously operating transmission and reception.

First, the flows of a transmit signal and a receive signal will be described. A tunable filter 3 is configured of a Tx filter 32 and an Rx filter 31, and connected to a transmission system including an antenna SW (switch) 2 and a PA (Power Amplifier) 62, and to a reception system including an LNA (Low Noise Amplifier) 61. A transmit signal outputted from an RFIC 6 is inputted to the PA 62, and amplified to a desired signal level. The transmit signal is then passed through a transmission side coupler 89 in a canceler 8 and a delay device 10, and inputted to the tunable filter 3. The Tx filter 32 in the tunable filter 3 suppresses thermal noise in the reception band, and the transmit signal is passed at a low loss. The transmit signal outputted from the tunable filter 3 is externally emitted from an antenna 1 through the antenna SW2.

On the other hand, a receive signal is inputted from the antenna 1, and inputted to the tunable filter 3 through the antenna SW2. The Rx filter 31 in the tunable filter 3 suppresses the leakage of the transmit signal, and the receive signal is passed at a low loss. The receive signal outputted from the tunable filter 3 is passed through a delay device 11, a reception side coupler 80 in the canceler 8, and an LNA (Low Noise Amplifier) 61, and inputted to the RFIC 6.

Since a typical duplexer suppresses the transmit signal by about 50 dB on the reception side, the influence of degrading the targeted receive signal is small, even though the out-of-band blocking at a level described in “3GPP TS25.101 V8.9.0 (2009-12)” is received is received at the antenna 1. In the case where a typical duplexer is replaced with a tunable duplexer module 7, the tunable duplexer module 7 is configured of the tunable filter 3, the canceler 8, the delay device 10, the delay device 11, and a control unit 5.

Before a mobile communication terminal starts transmission and reception, calibration is performed for providing a predetermined cancel value in the mobile communication terminal module. In performing calibration, even though the cancel value for the leakage component of the transmit signal that leaks to a receiver, for example, becomes 20 dB or more due to manufacture variations in devices, fluctuations in power supply voltage, changes in temperature, or the like, it is likely that the cancel value for the leakage component of thermal noise in the reception band generated by a transmitter becomes 20 dB or less.

In the case where the suppression value in the tunable filter 3 becomes about 30 dB, for example, and the suppression value is not enough for a Tx-Rx isolation of about 50 dB of a typical duplexer in association with the duplexer to be tunable, the control unit 5 adjusts an amplitude, a phase, and a bias voltage in such a way that the canceler 8 cancels the leakage component of the transmit signal and the leakage component of thermal noise by about 20 dB for each. Adjusting in this case means that the output signal of the PA 62 lead from the transmission side coupler 89 is used to generate a signal having the same amplitude as the transmit signal and the anti-phase of the transmit signal in the case of canceling the transmit signal, for example. To this end, the canceler 8 is configured of the transmission side coupler 89 that leads the output signal of the PA 62 in, an Rx filter 87 that attenuates the transmit signal to a predetermined level, an amplifier 8000 including a calibrating unit, a Tx filter 81 that attenuates thermal noise in the reception band to a predetermined level, and the reception side coupler 80 connected to the output side of the tunable filter 3.

It is noted that the control unit 5 is provided in the tunable duplexer module 7, and the control unit 5 sends and receives information necessary for control with the RFIC 6. The control unit 5 may be included in the RFIC 6.

Moreover, the configurations of the delay device 10 and the delay device 11 provided on the signal paths of the tunable filter 3 are determined by a time difference between the signal path of the tunable filter 3 and the signal path of the canceler 8. Since the group delay of the amplifier 8000 including the calibrating unit is a main factor of the time difference, the time difference may be generated in a wiring pattern or the like.

Furthermore, since it is expected that a loss occurs due to the wiring pattern, the delay device 10 is disposed in the transmission system and the delay device 11 is disposed in the reception system. However, the delay device may be disposed only in the transmission system or in the reception system.

In addition, the suppression value (about 30 dB) of the tunable filter 3 and the cancel value (about 20 dB) of the canceler 8 are examples, and the values are not limited thereto.

In the following, a block configuring the canceler 8 will be described in detail.

The transmission side coupler 89 is loosely coupled to the transmission system, and leads a transmit signal and thermal noise in the reception band attenuated by about 10 dB into the canceler 8, for example. On the other hand, the reception side coupler 80 is loosely coupled to the reception system, and attenuates the transmit signal that the amplitude and the phase are adjusted and thermal noise in the reception band by about 10 dB, for example, and combines the attenuated transmit signal and the thermal noise with the receive signal at the output of the tunable filter 3. The transmit signal is attenuated by about 30 dB at the Rx filter 87, for example, and thermal noise in the reception band is attenuated by about 30 dB at the Tx filter 81, for example.

Since the transmit signal and thermal noise in the reception band are canceled at the reception side coupler 80, the amplifier 8000 including the calibrating unit needs a gain of about 20 dB in order to compensate an attenuation of about 10 dB in both of the transmission side coupler 89 and the reception side coupler 80. Moreover, in order to highly accurately generate a signal having the same amplitude as the lead transmit signal and the anti-phase of the lead transmit signal, the amplifier 8000 includes a matching unit 86 at the input end, a matching unit 82 at the output end, an amplitude adjusting unit 85, a phase adjusting unit 84, and a bias adjusting unit 83. The order of disposing the amplitude adjusting unit 85, the phase adjusting unit 84, and the bias adjusting unit 83 is an example, and the order is not limited thereto. Furthermore, an attenuation of about 10 dB due to the degree of coupling of the reception side coupler 80, an attenuation of about 10 dB due to the degree of coupling of the transmission side coupler 89, and a gain of about 20 dB in the amplifier 8000 to compensate the attenuations are examples, and the attenuations and the gain are not limited thereto.

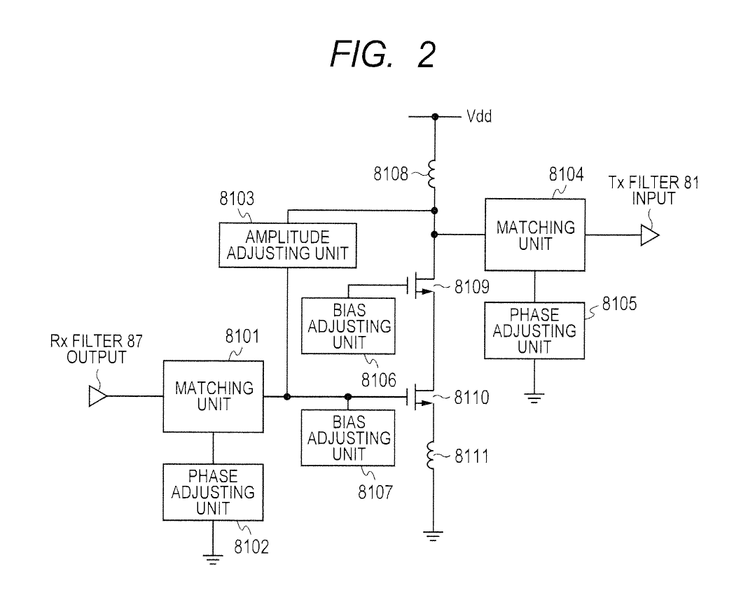

FIG. 2 is a circuit diagram of the amplifier including the calibrating unit according to the first embodiment. A matching unit 8101 and a matching unit 8104 are often configured of a passive device such as an inductor and a capacitor. An amplitude adjusting unit 8103 is configured of a semiconductor switch and a passive device such as a capacitor and a resister, for example, and the resistance is changed to adjust the amplitude. A phase adjusting unit 8102 and a phase adjusting unit 8105 are configured of a capacitor and a semiconductor switch, for example, and the capacitance is changed to adjust the phase. A bias adjusting unit 8106 and a bias adjusting unit 8107 are configured of a band gap reference circuit and a current source, for example, and adjust a bias voltage in such a way that the drain currents of MOS transistors 8109 and 8110 take the optimum values. An inductor 8108 and an inductor 8111 correspond to a load device and a matching device on the input side, respectively.

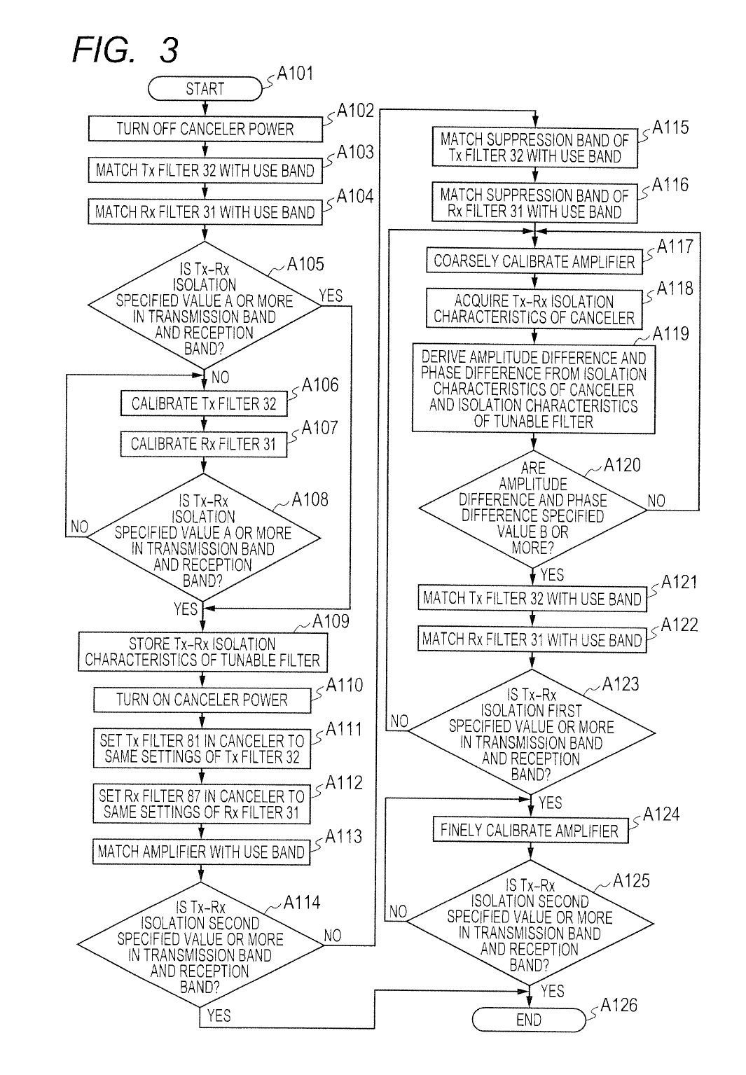

FIG. 3 is a flowchart of calibration according to the first embodiment. In the following, the calibration of the tunable duplexer module 7 will be described with reference to FIG. 3. Here, the description is made focusing on the process of calibrating the canceler 8 (A110) and the processes following A110 particularly. However, the overall flow will be described as well starting from the calibration of the tunable filter 3 performed prior to A110.

In starting (A101), first, the power supply of the canceler 8 is turned off in order to calibrate the tunable filter 3 (A102). Subsequently, the control unit 5 adjusts frequency band selecting units incorporated in the tunable filter 3 in order to set the use frequency band of the Tx filter 32 (A103) and the use frequency band of the Rx filter 31 (A104). The frequency band selecting unit is a component that selects a capacitor to select a band using a switch, for example, also including a scheme for compensating variations in the capacitor and the switch. Moreover, adjusting is performed after reading a frequency band selecting bit stored in a register in the canceler 8 or the RFIC 6 and setting the frequency band based on the selecting bit.

Subsequently, the Tx-Rx isolation characteristics of the tunable filter 3 set at the use frequency band are acquired, and it is determined whether the Tx-Rx isolation is a specified value A or more in the transmission band and the reception band of the use frequency band (A105). In the case where the Tx-Rx isolation is the specified value A or less, it is determined that the tunable filter 3 does not satisfy a predetermined performance due to variations in devices, for example, so that the Tx filter 32 is calibrated (A106) and the Rx filter 31 is calibrated (A107) until the Tx-Rx isolation is the specified value A or more. The calibration corresponds to the compensation of variations in the capacitor and the switch of the frequency band selecting unit.

As a result of the calibration, in the case where the Tx-Rx isolation is the specified value A or more in the transmission band and the reception band of the use frequency band (YES in A108), and in the case where the Tx-Rx isolation is the specified value A or more in the process A105, the Tx-Rx isolation characteristics of the tunable filter 3 are stored (A109). The Tx-Rx isolation characteristics may be stored in a memory provided in the tunable duplexer module 7 or the RFIC 6, for example.

The processes so far are the calibration performed only by the tunable filter 3. Supposing a Tx-Rx isolation of about 30 dB is expected as the specified value A through the calibration only by the tunable filter 3, for example. In this expectation, in the case where the Tx-Rx isolation is only 28 dB due to variations, for example, the tunable filter 3 is adjusted so as to obtain an isolation of 30 dB or more through the flow to the process A109. In the flow of the subsequent process A110 and the following processes, the canceler 8 is calibrated and adjusted in such a way that the entire tunable duplexer module 7 obtains an isolation of 50 dB or more, which is necessary for the communication system, for example.

Subsequently, in order to calibrate the canceler 8, the power supply of the canceler 8 is turned on (A110). The frequency band selecting unit is adjusted in such a way that the Tx filter 81 and the Rx filter 87 in the canceler 8 have the same settings as the Tx filter 32 and the Rx filter 31 (A111 and A112). Subsequently, in order to set the use frequency band of the amplifier 8000 including the calibrating unit (A113), the amplitude adjusting unit 85, the phase adjusting unit 84, and the bias adjusting unit 83 are adjusted so as to have preset characteristics for the use frequency band.

For the adjusting, the control unit 5 supplies a predetermined control bit to the canceler 8, for example. The Tx-Rx isolation is acquired while changing the control bit using the canceler 8 having standard characteristics in advance, and a control bit to obtain a targeted value is set to a predetermined control bit. The canceler 8 operates according to the predetermined control bit if the characteristics of the canceler 8 are not varied, so that the Tx-Rx isolation will have a targeted value (50 dB in the example) or more in the transmission band and the reception band of the use frequency band. However, since the characteristics of the canceler 8 are varied actually, the Tx-Rx isolation is not always a targeted value.

Therefore, the control unit 5 acquires the Tx-Rx isolation characteristics of the tunable duplexer module 7 set at the use frequency band in the process A113, and determines whether the Tx-Rx isolation is a second specified value (50 dB in the example) or more in the transmission band and the reception band of the use frequency band (A114). In the case where the Tx-Rx isolation is the second specified value or more, since adjusting is unnecessary to be performed in the subsequent processes, calibration is ended as it is (A126). In the case where the Tx-Rx isolation is the second specified value or less, it is determined that the canceler 8 does not operate as expected due to variations.

Therefore, in order to solve the problem of the canceler 8 due to variations, the Tx-Rx isolation characteristics of the canceler 8 are acquired. In order to suppress the signal passed through the delay device 10, the tunable filter 3, and the delay device 11 and to enable the characteristics of only the canceler 8 to be measured, first, the frequency band selecting unit of the Tx filter 32 of the tunable filter 3 is adjusted, and the use frequency band is set to a suppression band (A115). The frequency band selecting unit of the Rx filter 31 is similarly adjusted, and the use frequency band is set to a suppression band (A116).

Subsequently, in combining the signal supplied to the reception side coupler 80 through the canceler 8 with the output signal of the delay device 11 in the use band, first, the amplifier 8000 including the calibrating unit is coarsely calibrated in order that the amplitudes of the signals are equivalent to each other and the phases are inverted to each other (A117).

Coarse calibration means calibration that in order to compensate manufacture variations in devices, fluctuations in power supply voltage, changes in temperature, or the like, such a point is determined that the amplitudes are equivalent to each other and the phases are inverted to each other while appropriately changing the settings of bits to control the characteristics of the amplitude adjusting unit 85, the phase adjusting unit 84, and the bias adjusting unit 83 from control bits stored in advance in the register in the tunable duplexer module 7 or the RFIC 6, for example.

Since the use frequency bands of a Tx filter 8132 and an Rx filter 8731 are set to a suppression band in the processes A115 and A116 in acquiring the characteristics of the canceler 8, it is characterized in that the amplitude characteristic and phase characteristic of only the canceler 8 can be measured for a short time in a wide range of the control bits.

In coarse calibration, the Tx-Rx isolation characteristics of the canceler are acquired (A118), the Tx-Rx isolation characteristics of the canceler are compared with the Tx-Rx isolation characteristics of the tunable filter 3 stored in the process A109, and an amplitude difference and a phase difference between the Tx-Rx isolation characteristics of the canceler and the Tx-Rx isolation characteristics of the tunable filter 3 are derived (A119). It is determined whether the obtained amplitude difference and the obtained phase difference are a specified value B or less (A120), and the processes A117 to A120 are repeatedly performed until the obtained amplitude difference and the obtained phase difference are below the specified value B.

In the case where the amplitude difference and the phase difference are the specified value B or less (YES in A120), the control unit 5 adjusts the frequency band selecting unit in such a way that the characteristics of the Tx filter 32 and the Rx filter 31 are returned to the settings in the use frequency band set in the processes A103 and A104 (A121 and A122).

Subsequently, the control unit 5 acquires the Tx-Rx isolation characteristics of the tunable duplexer module 7 coarsely calibrated, and determines whether the Tx-Rx isolation is the first specified value (45 dB in the example, for example) or more in the transmission band and the reception band of the use frequency band (A123). In the case where the Tx-Rx isolation is the first specified value or less, the process is again returned to the process for coarsely calibrating the amplifier 8000 including the calibrating unit (A117), and another control bit to be the first specified value or more is determined.

In the case where the Tx-Rx isolation is the first specified value or more (YES in A123), it is considered that the Tx-Rx isolation is significantly close to the target (50 dB in the example) for a short time through coarse calibration from the processes A117 to A120 even though the Tx-Rx isolation is not satisfied. To this end, the amplifier 8000 including the calibrating unit is finely calibrated (A124).

In fine calibration, the settings of bits to control the characteristics of the amplitude adjusting unit 85, the phase adjusting unit 84, and the bias adjusting unit 83 are changed in a narrow range near the value determined in the coarse calibration, so that the Tx-Rx isolation improved for a short time in the transmission band and the reception band of the use frequency band is further improved.

In fine calibration, the settings of the use frequency bands of the Tx filter 8132 and the Rx filter 8731 are returned to the settings in actually performing transmission and reception, and the isolation value (50 dB, for example) is measured. Since the targeted characteristics themselves are measured, isolation can be set in excellent accuracy. Generally, it takes time to measure the isolation value. However, since the control bit already has a value close to the optimum value by coarse calibration, time to reach the optimum value can be shortened.

The Tx-Rx isolation characteristics of the tunable duplexer module 7, which is thus finely calibrated, are acquired, and it is determined whether the Tx-Rx isolation is the second specified value or more in the transmission band and the reception band of the use frequency band (A125). In the case where the Tx-Rx isolation is the second specified value or less, the process is again returned to the process for finely calibrating the amplifier 8000 including the calibrating unit (A124), and another control bit to be the second specified value or more is determined.

In the case where the Tx-Rx isolation is the second specified value or more, the target is cleared, and calibration is ended (A126).

It is noted that as described above, the second specified value is a request performance such as a Tx-Rx isolation of 50 dB or more, for example. On the other hand, the first specified value conforms to the second specified value; the Tx-Rx isolation may be 45 dB, for example, and the first specified value may be a value to reach a request performance of 50 dB by adjusting the amplitude, the phase, and the bias voltage in the processes from A124 to A125.

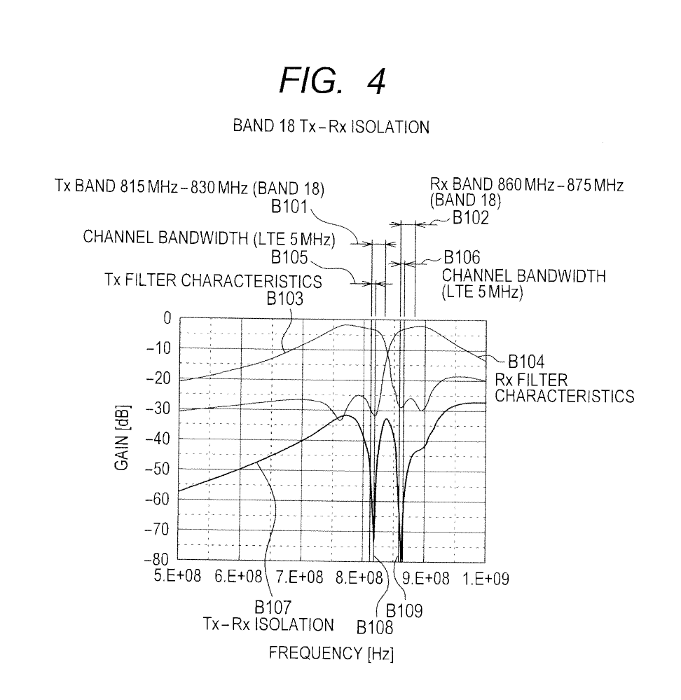

FIGS. 4, 5, and 6 are the Tx filter characteristics (B103, B112, and B121) of a band 18, the Rx filter characteristics (B104, B113, and B122) of a band 5, and the Tx-Rx isolation characteristics of the tunable duplexer module 7 (B107, B116, and B125) of a band 8, respectively. The frequency band selecting units of the filters and the amplitude adjusting unit 85, the phase adjusting unit 84, and the bias adjusting unit 83 of the amplifier 8000 including the calibrating unit are adjusted according to the flowchart in FIG. 3, so that in FIG. 4, an isolation of 50 dB or more is obtained (B108) in the channel bandwidth (5 MHz in LTE) (B105) of a transmission band of 815 to 830 MHz (B101), and an isolation of 50 dB or more is obtained (B109) in the channel bandwidth (5 MHz in LTE) (B106) in a reception band of 860 to 875 MHz (B102).

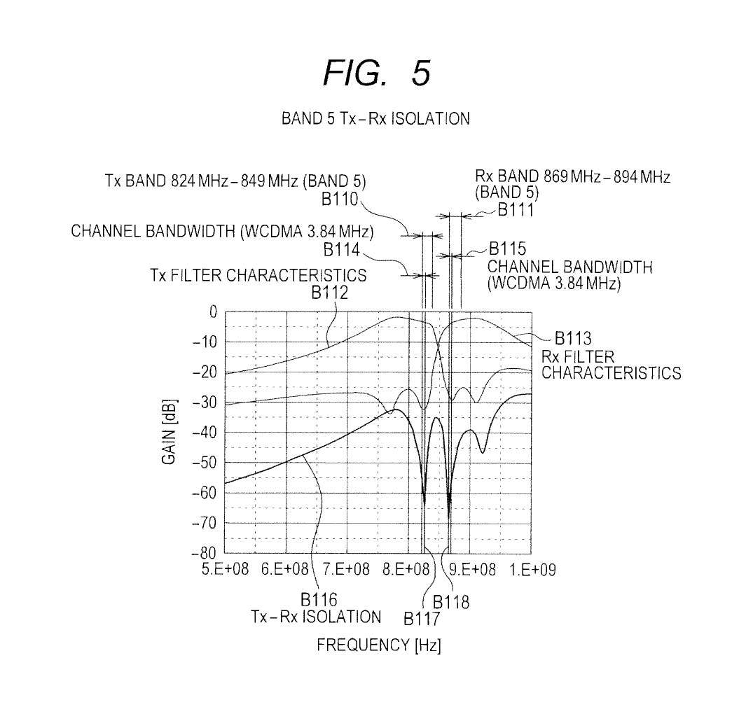

Moreover, in FIG. 5, an isolation of 50 dB or more is obtained (B117) in the channel bandwidth (3.84 MHz in WCDMA) (B114) of a transmission band of 824 to 849 MHz (B110), and an isolation of 50 dB or more is obtained (B118) in the channel bandwidth (3.84 MHz in WCDMA) (B115) of a reception band of 869 to 894 MHz (B111).

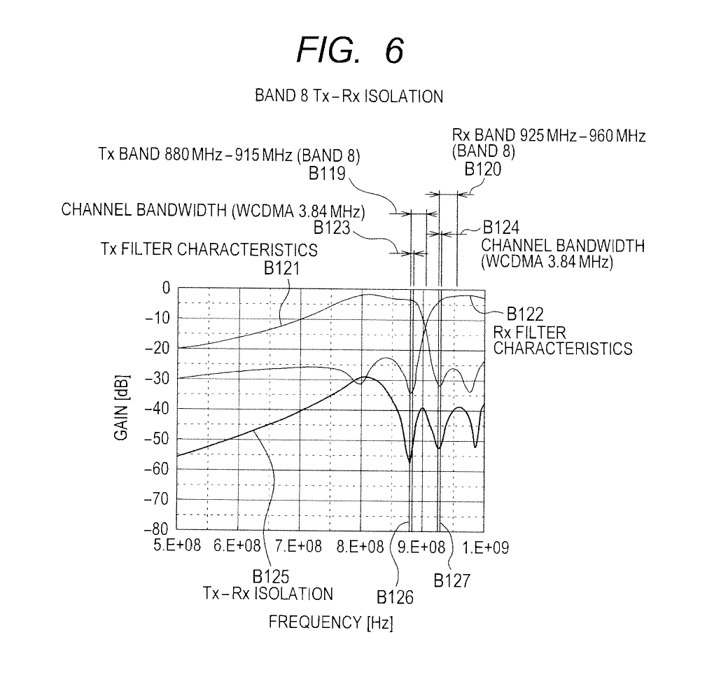

Furthermore, in FIG. 6, an isolation of 50 dB or more is obtained (B126) in the channel bandwidth (3.84 MHz in WCDMA) (B123) of a transmission band of 880 to 915 MHz (B119), and an isolation of 50 dB or more is obtained (B127) in the channel bandwidth (3.84 MHz in WCDMA) (B124) of a reception band of 925 to 960 MHz (B120). Therefore, characteristics equivalent to a typical duplexer or more are obtained in a plurality of frequency bands.

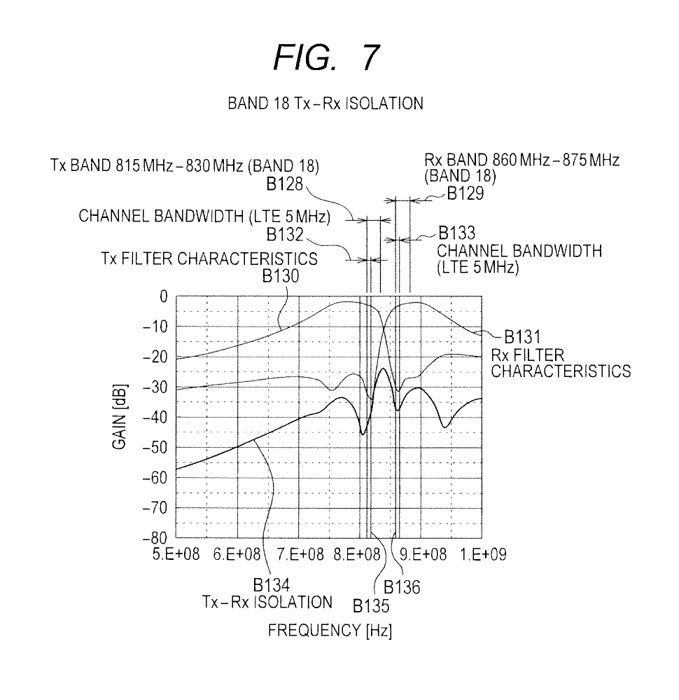

FIG. 7 is the Tx filter characteristics (B130), the Rx filter characteristics (B131), and the Tx-Rx isolation characteristics (B134) of the band 18 before calibrated. The isolation is 50 dB or less (B135) in the channel bandwidth (5 MHz in LTE) (B132) of a transmission band of 815 to 830 MHz (B128), and the isolation is 50 dB or less (B136) in the channel bandwidth (5 MHz in LTE) (B133) of a reception band of 860 to 875 MHz (B129).

It is revealed that even isolations which do not satisfy request performance before calibration as shown in FIG. 7 can obtain an isolation of 50 dB or more, which is a target both in the transmission band and the reception band, by performing calibration according to the embodiment as shown in FIG. 4.

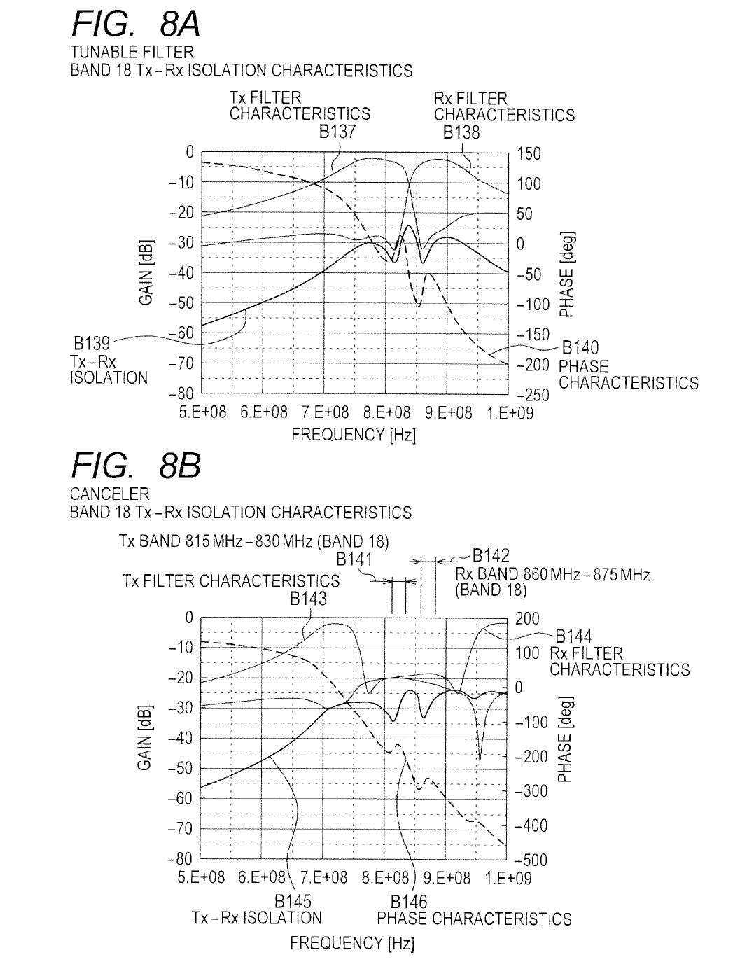

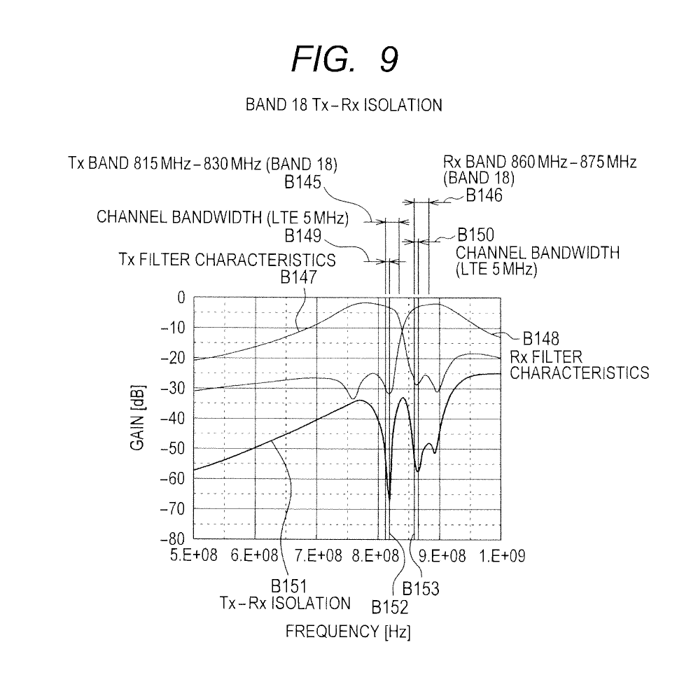

Next, the embodiment will be described based on the characteristics obtained in the processes in the flowchart in FIG. 3 with reference to FIGS. 8A, 8B, and 9.

FIG. 8A shows the Tx filter characteristics (B137), the Rx filter characteristics (B138), the Tx-Rx isolation characteristics (B139), and the phase characteristics (B140) of the tunable filter 3.

FIG. 8B shows the Tx-Rx isolation characteristics (B145) and the phase characteristics (B146) of the canceler 8. In acquiring the Tx-Rx isolation characteristics and the phase characteristics (B146) of the canceler 8 (B145), since the use band of the tunable filter 3 is set to a suppression band as described in the flowchart in FIG. 3, the Tx filter characteristics (B143) have a suppression band in a transmission band of 815 to 830 MHz (B141), and the Rx filter characteristics (B144) have a suppression band in a reception band of 860 to 875 MHz (B142).

B139 and B140 in FIG. 8A are characteristics stored in the process A109 in the flowchart in FIG. 3. Moreover, B145 and B146 in FIG. 8B are characteristics acquired in the process A118 in the flowchart in FIG. 3, and used for deriving the amplitude difference and the phase difference in the process A119. Although these characteristics can be acquired using a measurement device such as a network analyzer, in the case where the characteristics are acquired in the mobile communication terminal, the modulation signal of the use band may be used. For example, as described in “3GPP TS36.211 V8.9.0 (2009-12)”, since the uplink signal in the LTE mode includes a reference signal modulated for monitoring transmission line characteristics, the reference signal is used to acquire an amplitude change value and a phase change value for the transmission line characteristics of the tunable filter 3, for example. Furthermore, the use band of the tunable filter 3 is set to a suppression band to acquire an amplitude change value and a phase change value for the transmission line characteristics of the canceler 8, for example. An amplitude difference and a phase difference can be determined from the acquired amplitude change value and phase change value of the tunable filter 3 and the acquired amplitude change value and phase change value of the canceler 8. A more excellent cancel effect is expected as the amplitude difference is smaller and the phase difference is closer to an angle of 180 degrees.

It is noted that in order to acquire the transmission line characteristics of the canceler 8, the use band of the tunable filter 3 is set to a suppression band. The transmission line characteristics in operating the canceler 8 (the tunable filter 3 is set optimum to the use band) are not always matched with the acquired transmission line characteristics.

However, since an approximate convergence can be found, such an effect is exerted that calibration time is shortened as compared with the case where the amplitude, the phase, and the bias voltage are adjusted for no target.

Furthermore, in acquiring the transmission line characteristics, some scheme is necessary such as turning off the antenna SW2 in order to prevent radio waves from being externally emitted.

FIG. 9 is the Tx filter characteristics (B147), the Rx filter characteristics (B148), and the Tx-Rx isolation characteristics (B151) of the band 18 in the case where calibration is performed according to the flowchart in FIG. 3 and determination is YES in the process A125. Since the deterioration of performance due to variations in devices, fluctuations in power supply voltage, and changes in temperature can be compensated highly accurately, the isolation is 50 dB or more (B152) in the channel bandwidth (5 MHz in LTE) (B149) of a transmission band of 815 to 830 MHz (B145), and the isolation is 50 dB or more (B153) in the channel bandwidth (5 MHz in LTE) (B150) of a reception band of 860 to 875 MHz (B146). Namely, according to the embodiment, also in the case of using the tunable duplexer, such an effect is exerted that the Tx-Rx isolation characteristics equivalent to a typical, conventional duplexer or more can be obtained in a plurality of frequency bands.

It is noted that although both of FIGS. 9 and 4 are the characteristics of the band 18, the surrounding environments when characteristics are acquired are different and there are slight differences in detail because of low temperature, for example. However, characteristics that satisfy targeted performance are still obtained.

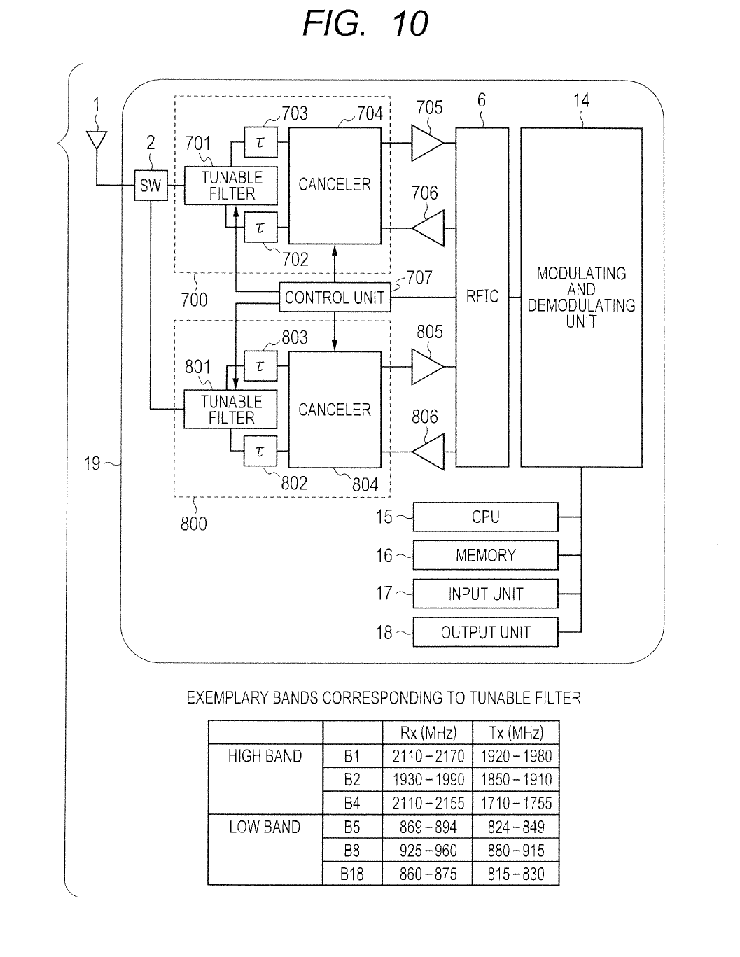

FIG. 10 is a block diagram of a mobile communication terminal to which the embodiment is applied. In the case where bands 1, 2, 4, 5, 8, and 18 are received as an example of a multiband, the terminal is configured in such a way that the bands 5, 8, and 18 in a band of 800 M to 900 MHz are a low band, and the bands 1, 2, and 4 in a band of 1,700 M to 2,100 MHz are a high band.

A mobile communication terminal 19 is configured of the antenna 1, the antenna SW2, a tunable duplexer module 700, a tunable duplexer module 800, the RFIC 6, an LNA 705, a PA 706, an LNA 805, a PA 806, a control unit 707, a modulating and demodulating unit 14, a CPU 15, a memory 16, an input unit 17, and an output unit 18.

For example, the tunable duplexer module 700 may conform to a high band, and the tunable duplexer module 800 may conform to a low band.

The tunable duplexer module 700 is configured of a tunable filter 701, a canceler 704, a delay device 702, and a delay device 703. The tunable duplexer module 800 is configured of a tunable filter 801, a canceler 804, a delay device 802, and a delay device 803. Both of the tunable duplexer module 700 and the tunable duplexer module 800 are controlled by the control unit 707.

The processes (A109 and A118) for obtaining the transmission line characteristics of the tunable filter 3 and the transmission line characteristics of the canceler 8 will be described with reference to FIG. 10. A reference signal, which is one of the uplink signals in the LTE mode generated at the modulating and demodulating unit 14, is up-converted to a transmission band and amplified to a predetermined level at the RFIC 6. Subsequently, the reference signal is amplified to a predetermined level at the PA 706 or the PA 806, and inputted to the tunable duplexer module 700 or the tunable duplexer module 800. The reference signal outputted from the tunable duplexer module 700 or the tunable duplexer module 800 is passed through the LNA 705 or the LNA 805, and inputted to the RFIC 6. The reference signal is down-converted from the transmission band to the base band at the RFIC 6, and complex-divided by the original reference signal, so that the transmission line characteristics to the reference signal can be obtained. As described above, such settings are provided, in which the power supply of the canceler 8 is turned off in acquiring the transmission line characteristics of the tunable filter 3 (A109), and the use frequency bands of the Tx filter 8132 and the Rx filter 8731 are suppression bands in acquiring the transmission line characteristics of the canceler 8 (A118).

### Second Embodiment

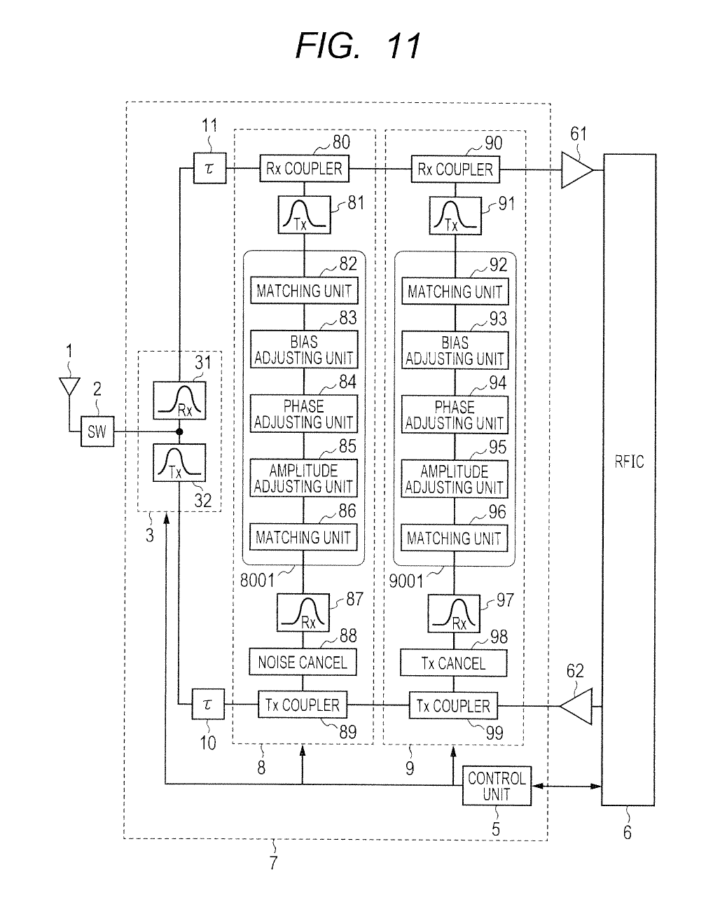

FIG. 11 is a block diagram of an exemplary configuration of a mobile communication terminal module according to a second embodiment. Since the flows of the transmit signal and the receive signal are the same as in the first embodiment, the description is omitted. Here, a signal to cancel the leakage component of the transmit signal at the output of a PA 62 is generated at a canceler 8, and a signal to cancel the leakage component of thermal noise in the reception band is generated at a canceler 9. The canceler 8 includes a noise canceler 88 that removes thermal noise in the reception band, and the canceler 9 includes a Tx canceler 98 that removes a transmit signal.

In the following, blocks configuring the canceler 8 and the canceler 9 will be described in detail.

A transmission side coupler 89 is loosely coupled to a transmission system, and leads a transmit signal and thermal noise in the reception band attenuated by about 10 dB into the canceler 8. On the other hand, a reception side coupler 80 is loosely coupled to a reception system, attenuates a transmit signal, which the amplitude and the phase are adjusted, by about 10 dB, and then combines the transmit signal with the reception system at the output of a tunable filter 3. The transmit signal is attenuated by about 30 dB at an Rx filter 87, and thermal noise in the reception band is attenuated by about 30 dB at a Tx filter 81.

In order to highly accurately generate a signal having the same amplitude as the lead transmit signal and the anti-phase of the lead transmit signal, an amplifier 8001 including a calibrating unit includes a matching unit 86 at the input end, a matching unit 82 at the output end, an amplitude adjusting unit 85, a phase adjusting unit 84, and a bias adjusting unit 83. The order of disposing the amplitude adjusting unit 85, the phase adjusting unit 84, and the bias adjusting unit 83 is an example, and the order is not limited thereto.

The noise canceler 88 may be configured of a phase shifter and a synthesizer. Thermal noise in the reception band at the output of the PA 62 is inverted at an angle of 180 degrees at the phase shifter, the thermal noise in the reception band is canceled at the synthesizer, and a transmit signal that is not phase-inverted is passed.

On the other hand, a transmission side coupler 99 is loosely coupled to the transmission system, and leads a transmit signal and thermal noise in the reception band attenuated by about 10 dB into the canceler 9. On the other hand, a reception side coupler 90 is loosely coupled to the reception system, attenuates thermal noise in the reception band, which the amplitude and the phase are adjusted, by about 10 dB, and combines the thermal noise with the reception system at the output of the tunable filter 3. The transmit signal is attenuated by about 30 dB at an Rx filter 97, and thermal noise in the reception band is attenuated by about 30 dB at a Tx filter 91.

In order to highly accurately generate a signal having the same amplitude as the lead transmit signal and the anti-phase of the lead transmit signal, an amplifier 9001 including a calibrating unit includes a matching unit 96 at the input end, a matching unit 92 at the output end, an amplitude adjusting unit 95, a phase adjusting unit 94, and a bias adjusting unit 93. The order of disposing the amplitude adjusting unit 95, the phase adjusting unit 94, and the bias adjusting unit 93 is an example, and the order is not limited thereto.

The Tx canceler 98 may be configured of a phase shifter and a synthesizer. The transmit signal at the output of the PA 62 is inverted at an angle of 180 degrees at the phase shifter, the transmit signal is canceled at the synthesizer, and thermal noise in the reception band that is not phase-inverted is passed.

In calibrating a tunable duplexer module 7, as similar to the first embodiment, first, the tunable filter 3 is calibrated. After the calibration, the Tx-Rx isolation characteristics of the tunable filter 3 are stored in a memory provided in the tunable duplexer module 7 or an RFIC 6. Subsequently, in calibrating the canceler 8 and the canceler 9, the Tx-Rx isolation characteristics of the canceler 8 and the Tx-Rx isolation characteristics of the canceler 9 are acquired. In acquiring the Tx-Rx isolation characteristics, the use band of the tunable filter 3 is set to a suppression band, and one of the power supplies of the canceler 8 and the canceler 9 is turned off in such away that no interference occurs between the canceler 8 and the canceler 9. An amplitude difference and a phase difference can be determined from the amplitude change value and phase change value of the acquired tunable filter 3, the amplitude change value and phase change value of the canceler 8, and the amplitude change value and phase change value the canceler 9. The amplitude, the phase, and the bias voltage are adjusted based on the determined amplitude difference and the determined phase difference.

In the embodiment, a signal to cancel the transmit signal at the output of the PA 62 is generated at the canceler 8, and a signal to cancel thermal noise in the reception band is generated at the canceler 9, so that a band covered by a single canceler is small. Accordingly, it is possible to improve the accuracy of the cancel value.

### Third Embodiment

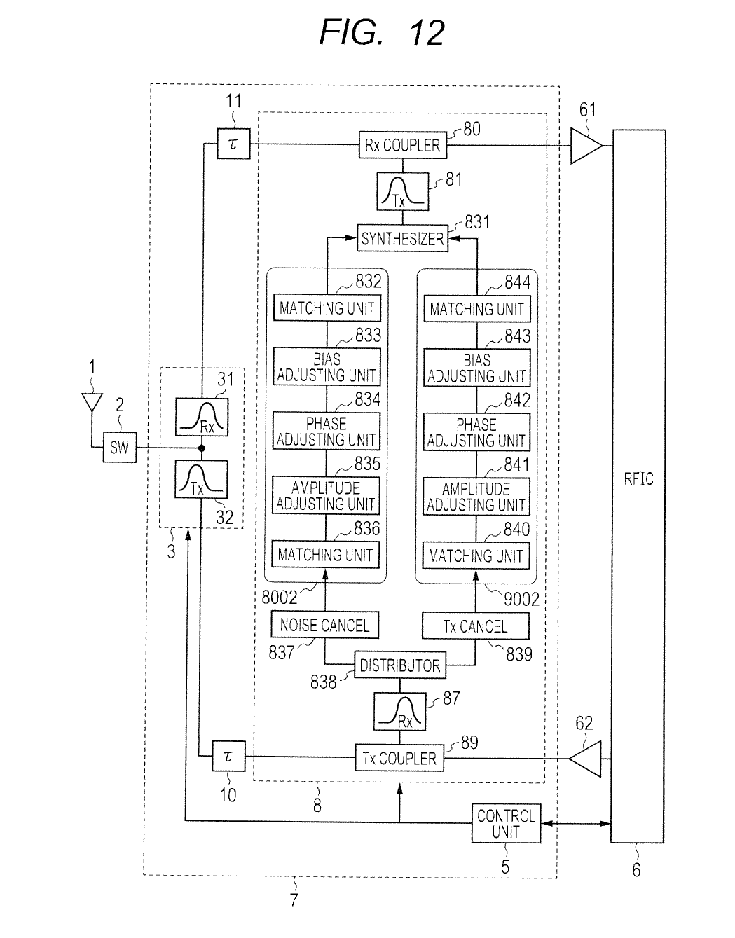

FIG. 12 is a block diagram of an exemplary configuration of a mobile communication terminal module according to a third embodiment. Since the flows of the transmit signal and the receive signal are the same as in the first embodiment, the description is omitted. Here, a signal to cancel the leakage component of a transmit signal at the output of a PA 62 and a signal to cancel the leakage component of thermal noise in the reception band are generated at a canceler 8. A signal path is branched in the canceler 8, a signal to cancel the transmit signal is generated on one of the branched paths and a signal to cancel thermal noise in the reception band is generated on the other of the branched paths. A system to generate a signal to cancel the transmit signal includes a noise canceler 837 that removes thermal noise in the reception band, and a system to generate a signal to cancel thermal noise in the reception band includes a Tx canceler 839 that removes the transmit signal.

In the following, a block configuring the canceler 8 will be described in detail.

A transmission side coupler 89 is loosely coupled to a transmission system, and leads a transmit signal and thermal noise in the reception band attenuated by about 10 dB into the canceler 8. On the other hand, a reception side coupler 80 is loosely coupled to a reception system, attenuates a transmit signal that the amplitude, the phase, and delay are adjusted and thermal noise in the reception band by about 10 dB, and then combines the transmit signal with the reception system at the output of a tunable filter 3. The transmit signal is attenuated by about 30 dB at an Rx filter 87, and thermal noise in the reception band is attenuated by about 30 dB at a Tx filter 81. A distributor 838 is connected to the output of the Rx filter 87, and branches the path to the noise canceler 837 and to the Tx canceler 839. A synthesizer 831 is connected to the input of the Tx filter 81 for combining the branched systems. In order to highly accurately generate a signal having the same amplitude as the lead transmit signal and the anti-phase of the lead transmit signal, an amplifier 8002 including a calibrating unit includes a matching unit 836 at the input end, a matching unit 832 at the output end, an amplitude adjusting unit 835, a phase adjusting unit 834, and a bias adjusting unit 833. The order of disposing the amplitude adjusting unit 835, the phase adjusting unit 834, and the bias adjusting unit 833 is an example, and the order is not limited thereto.

On the other hand, in order to highly accurately generate a signal having the same amplitude as the lead transmit signal and the anti-phase of the lead transmit signal, an amplifier 9002 including a calibrating unit includes a matching unit 840 at the input end, a matching unit 844 at the output end, an amplitude adjusting unit 841, a phase adjusting unit 842, and a bias adjusting unit 843. The order of disposing the lead transmit signal the amplitude adjusting unit 841, the phase adjusting unit 842, and the bias adjusting unit 843 is an example, and the order is not limited thereto.

The noise canceler 837 may be configured of a phase shifter and a synthesizer. Thermal noise in the reception band at the output of the distributor 838 is inverted at an angle of 180 degrees at the phase shifter, the thermal noise in the reception band is canceled at the synthesizer, and a transmit signal that is not phase-inverted is passed.

The Tx canceler 839 may be configured of a phase shifter and a synthesizer. The transmit signal at the output of the distributor 838 is inverted at an angle of 180 degrees at the phase shifter, the transmit signal is canceled at the synthesizer, and thermal noise in the reception band that is not phase-inverted is passed.

In calibrating a tunable duplexer module 7, as similar to the first embodiment, first, the tunable filter 3 is calibrated. After the calibration, the Tx-Rx isolation characteristics of the tunable filter 3 are stored in a memory provided in the tunable duplexer module 7 or an RFIC 6. Subsequently, in calibrating the canceler 8, the Tx-Rx isolation characteristics of the canceler 8 are acquired. In acquiring the Tx-Rx isolation characteristics, the use band of the tunable filter 3 is set to a suppression band, and one of the power supplies of the canceler 8 and the canceler 9 is turned off in such a way that no interference occurs between the amplifier 8002 including the calibrating unit and the amplifier 9002. An amplitude difference and a phase difference can be determined from the amplitude change value and phase change value of the acquired tunable filter 3 and the amplitude change value and phase change value of the canceler 8. The amplitude, the phase, and the bias voltage are adjusted based on the determined amplitude difference and the determined phase difference.

In the embodiment, since the transmit signal and thermal noise in the reception band at the output of the PA 62 are separately processed in the canceler 8, a band covered by a single wide band amplifier is small. Accordingly, it is possible to improve the accuracy of the cancel value. Moreover, since only one transmission side coupler and only one reception side coupler are provided, it is possible to reduce transmission losses in the transmission system and the reception system.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A mobile communication terminal module that simultaneously operates transmission and reception using a transmit frequency and a receive frequency in different bands, the mobile communication terminal module comprising:
a filter configured to separate a transmit signal from a receive signal, the filter including a variable characteristic to selectively transmit a plurality of frequency bands; and
a canceler configured to cancel a transmit signal and thermal noise in a reception band leaking from a transmission side to a reception side by a predetermined amount, wherein:
the canceler includes an amplifier having a calibrating unit; and
the calibrating unit includes an amplitude adjusting unit, a phase adjusting unit, and a bias adjusting unit.

2. The mobile communication terminal module according to claim 1,
wherein the calibrating unit performs a plurality of steps of calibration to cancel the transmit signal and thermal noise in the reception band leaking from the transmission side to the reception side by a predetermined amount, performs coarse calibration, and performs fine calibration.

3. The mobile communication terminal module according to claim 2,
wherein in performing the coarse calibration, the calibrating unit adjusts the amplitude adjusting unit, the phase adjusting unit, and the bias adjusting unit based on an amplitude difference and a phase difference determined by acquiring amplitude characteristics and phase characteristics of the filter and the canceler.

4. The mobile communication terminal module according to claim 3,
wherein in performing the fine calibration, the calibrating unit adjusts the amplitude adjusting unit, the phase adjusting unit, and the bias adjusting unit near a convergence determined in the coarse calibration.

5. A mobile communication terminal that simultaneously operates transmission and reception using a transmit frequency and a receive frequency in different bands, the mobile communication terminal comprising:
a filter configured to separate a transmit signal from a receive signal, the filter including a variable characteristic to selectively transmit a plurality of frequency bands; and
a canceler configured to cancel a transmit signal and thermal noise in a reception band leaking from a transmission side to a reception side by a predetermined amount, wherein:
the canceler includes an amplifier having a calibrating unit;
the calibrating unit includes an amplitude adjusting unit, a phase adjusting unit, and a bias adjusting unit; and
the calibrating unit performs a plurality of steps of calibration to cancel the transmit signal and thermal noise in the reception band leaking from the transmission side to the reception side by a predetermined amount, performs coarse calibration, and performs fine calibration.

6. The mobile communication terminal according to claim 5, wherein:
in performing the coarse calibration, the calibrating unit adjusts the amplitude adjusting unit, the phase adjusting unit, and the bias adjusting unit based on an amplitude difference and a phase difference determined by acquiring amplitude characteristics and phase characteristics of the filter and the canceler; and
in performing the fine calibration, the calibrating unit adjusts the amplitude adjusting unit, the phase adjusting unit, and the bias adjusting unit near a convergence determined in the coarse calibration.
